(19) United States
(12) Patent Application Publication
(10) Pub. No.: US 2014/0295288 A1
(43) Pub. Date: Oct. 2, 2014

(54) NON-AQUEOUS ORGANIC ELECTROLYTE, LITHIUM ION SECONDARY BATTERY CONTAINING NON-AQUEOUS ORGANIC ELECTROLYTE, PREPARATION METHOD OF LITHIUM ION SECONDARY BATTERY AND TERMINAL COMMUNICATION DEVICE

(71) Applicant: Huawei Technologies Co., Ltd., Shenzhen (CN)

(72) Inventor: Jie DING, Shenzhen (CN)

(21) Appl. No.: 14/306,951

(22) Filed: Jun. 17, 2014

Related U.S. Application Data
(63) Continuation of application No. PCT/CN2012/080501, filed on Aug. 23, 2012.

(30) Foreign Application Priority Data
Dec. 26, 2011 (CN) 201110441051.4

(51) Int. Cl. H01M 10/0569; H01M 10/0525

(52) U.S. Cl. CPC H01M 10/0569; H01M 10/0525
USPC 429/331

(57) ABSTRACT

A non-aqueous organic electrolyte including a lithium salt; a non-aqueous organic solvent, which includes γ-butyrolactone and a saturated cyclic ester compound shown in formula (I); an unsaturated cyclic ester compound shown in formula (II); and a dinitrile compound shown in formula (III), as well as a lithium ion secondary battery comprising same, which has excellent chemical stability and electrochemical stability and other desirable properties.

### CROSS-REFERENCE TO RELATED APPLICATIONS

This application is a continuation of International Patent Application No. PCT/CN2012/080501, filed on Aug. 23, 2012, which claims priority to Chinese Patent Application No. 201110441051.4, filed on Dec. 26, 2011, both of which are hereby incorporated by reference in their entireties.

### TECHNICAL FIELD

The present application relates to the field of lithium ion secondary batteries, and in particular, to a non-aqueous organic electrolyte, a lithium ion secondary battery containing the non-aqueous organic electrolyte, a preparation method of the lithium ion secondary battery and a terminal communication device.

### BACKGROUND

Consisting of a positive electrode, a negative electrode and an electrolyte, a lithium ion battery is a high-energy battery capable of charge and discharge, which carries out energy exchange by intercalation or deintercalation of Li⁺ in or from positive and negative electrode materials. With the expansion of application fields of lithium ion secondary batteries, including introduction of new application scenarios, such as large-scale energy storage power stations and high-temperature base station backup power, in recent years, and in particular, the continuous development and application of high-energy positive electrode materials, requirements for high-energy lithium ion secondary batteries become more urgent.

Generally, in order to obtain high energy of lithium ion secondary batteries, positive electrode active materials with a high capacity or a high intercalation-deintercalation platform are generally selected. However, side reactions tend to occur on an electrode surface in an electrolyte in a full-charged high-voltage battery system, in particular oxidation decomposition reactions of a non-aqueous organic electrolyte on a positive electrode active material. The performance of lithium ion secondary batteries is prone to aging during high-voltage and high-temperature storage. This is mainly because of the decomposition of an organic solid electrolyte interface (SEI) film covering the carbon negative electrode surface of a lithium ion secondary battery due to electrochemical energy and thermal energy with long-time exposure to high voltages and high temperature (45-60° C.), and this decomposition increases with time.

With the SEI film being damaged gradually, side reactions successively take place between a carbonate solvent in the non-aqueous organic electrolyte and a carbon negative electrode surface exposed due to the damage of the SEI film to generate gases continuously, which include gases from the decomposition of the carbonate solvent, such as CO, CO₂, CH₄, and C₂H₆. This depends on types of the non-aqueous organic electrolyte and carbon negative electrode active material in use. The generated gases may cause pressure inside the battery to increase, which result in battery expansion, severe deterioration of battery performance, and even inability to work normally with failure of the battery.

The electrolyte in a conventional lithium ion secondary battery in the prior art is a 4.2V system, which is far from being satisfactory for use of lithium ion secondary batteries with high voltages of 4.8 V and above. Therefore, it is of great significance to provide a non-aqueous organic electrolyte for use of a high-voltage lithium ion secondary battery, a lithium ion secondary battery containing the non-aqueous organic electrolyte, a preparation method of the lithium ion secondary battery, and a terminal communication device.

### SUMMARY

To solve the above problems, a first aspect of embodiments of the present application aims to provide a non-aqueous organic electrolyte which has excellent chemical stability and electrochemical stability and can inhibit decomposition of an electrolyte solvent under a high voltage and aerogenic expansion of a lithium ion secondary battery at high temperature during storage and thereby is satisfactory for use of lithium ion secondary batteries with high voltages of 4.8 V and above. A second aspect of the embodiments of the present application aims to provide a lithium ion secondary battery containing the above non-aqueous organic electrolyte, where the lithium ion secondary battery has excellent high-temperature storage and safety performance when being charged to a high voltage such as 4.8 V or above. A third aspect of the embodiments of the present application aims to provide a preparation method of the lithium ion secondary battery containing the above non-aqueous organic electrolyte.

In the first aspect, an embodiment of the present application provides a non-aqueous organic electrolyte, including:

(1) a lithium salt;

(2) a non-aqueous organic solvent which includes γ-butyrolactone and a saturated cyclic ester compound shown in formula (I),

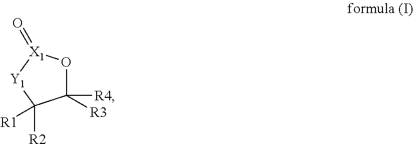

wherein X₁ is selected from a C, S or P group, Y₁ is selected from an O, CH2 or CH2CH2 group, and R1, R2, R3 and R4 are independently selected from hydrogen, halogen, cyano, nitro and a partially halogenated or perhalogenated carbon chain or ether group having one to six carbon atoms;

(3) an unsaturated cyclic ester compound shown in formula (II),

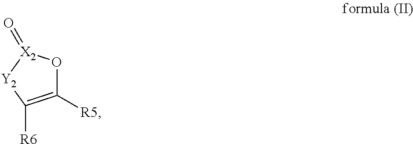

wherein X₂ is selected from a C or S group, Y₂ is selected from an O, CH2 or CH2CH2 group, and R5 and R6 are independently selected from hydrogen, halogen, cyano, nitro and a partially halogenated or perhalogenated carbon chain or ether group having one to six carbon atoms; and

(4) a dinitrile compound shown in formula (III),

NC—R7-CN formula (III),

where R7 is a hydrocarbyl or hydrocarbyl derivative having one to fifteen carbon atoms.

The lithium salt as a carrier is used to ensure basic operation of lithium ions in the lithium ion secondary battery. Preferably, the lithium salt is selected from one or more of LiPF₆, LiBF₄, LiSbF₆, LiClO₄, LiCF₃SO₃, LiAlO₄, LiAlCl₄, Li(CF₃SO₂)₂N, LiBOB (lithium bis(oxalate)borate), and LiDFOB (lithium difluoro(oxalate)borate). Preferably, a final concentration of the lithium salt in the non-aqueous organic electrolyte is 0.5-1.5 mol/L.

The non-aqueous organic solvent includes γ-butyrolactone (GBL) and the saturated cyclic ester compound shown in formula (I), and is used to dissolve the lithium salt.

The saturated cyclic ester compound shown in formula (I) is a 5-membered cyclic ester compound when Y₁ is selected from an O or CH2 group. The saturated cyclic ester compound shown in formula (I) is a 6-membered cyclic ester compound when Y₁ is selected from a CH2CH2 group.

Preferably, the saturated cyclic ester compound shown in formula (I) is one or more of the following: ethylene carbonate (Ethylene Carbonate, abbreviated as EC), propylene carbonate (Propylene Carbonate, abbreviated as PC), ethyl sulfonate, propyl sulfonate, ethyl phosphate, propyl phosphate, fluoroethylene carbonate (FEC), fluoropropylene carbonate, difluoropropylene carbonate, trifluoropropylene glycol ester, fluoro-γ-butyrolactone, difluoro-γ-butyrolactone, chloropropylene carbonate, dichloropropylene carbonate, trichloropropylene glycol ester, chloro-γ-butyrolactone, dichloro-γ-butyrolactone, bromopropylene carbonate, dibromopropylene carbonate, tribromopropylene glycol ester, bromo-γ-butyrolactone, dibromo-γ-butyrolactone, nitropropylene carbonate, nitro-γ-butyrolactone, cyanopropylene carbonate, cyano-γ-butyrolactone, fluoroethyl sulfonate, fluoropropylene sulfonate, difluoropropylene sulfonate, trifluoropropylene sulfonate, fluoro-γ-butyrolactone sulfonate, difluoro-γ-butyrolactone sulfonate, chloropropylene sulfonate, dichloropropylene sulfonate, trichloropropylene sulfonate, chloro-γ-butyrolactone sulfonate, dichloro-γ-butyrolactone sulfonate, bromopropylene sulfonate, dibromopropylene sulfonate, tribromopropylene sulfonate, bromo-γ-butyrolactone sulfonate, dibromo-γ-butyrolactone sulfonate, nitropropylene sulfonate, nitro-γ-butyrolactone sulfonate, cyanopropylene sulfonate, cyano-γ-butyrolactone sulfonate, fluoroethyl phosphate, fluoropropylene phosphate, difluoropropylene phosphate, trifluoropropylene phosphate, fluoro-γ-butyrolactone phosphate, difluoro-γ-butyrolactone phosphate, chloropropylene phosphate, dichloropropylene phosphate, trichloropropylene phosphate, chloro-γ-butyrolactone phosphate, dichloro-γ-butyrolactone phosphate, bromopropylene phosphate, dibromopropylene phosphate, tribromopropylene phosphate, bromo-γ-butyrolactone phosphate, dibromo-γ-butyrolactone phosphate, nitropropylene phosphate, nitro-γ-butyrolactone phosphate, cyanopropylene phosphate, cyano-γ-butyrolactone phosphate, and saturated cyclic ester compound derivatives of the above substances with a partially halogenated or perhalogenated branched carbon chain or ether group having one to six carbon atoms.

Preferably, the saturated cyclic ester compound shown in formula (I) in the non-aqueous organic solvent accounts for 5-50% by volume.

The γ-butyrolactone (GBL) and the saturated cyclic ester compound shown in formula (I) are mixed into a non-aqueous organic solvent. Preferably, a volume ratio of the γ-butyrolactone (GBL) to the saturated cyclic ester compound shown in formula (I) in the non-aqueous organic solvent is 1-10:1.

The unsaturated cyclic ester compound shown in formula (II) is an unsaturated 5-membered cyclic ester compound when Y₂ is selected from an O or CH2 group. The unsaturated cyclic ester compound shown in formula (II) is an unsaturated 6-membered cyclic ester compound when Y₂ is selected from a CH2CH2 group.

Preferably, the unsaturated cyclic ester compound shown in formula (II) is one or more of the following: vinylene carbonate (Vinylene Carbonate, abbreviated as VC), fluorovinylene carbonate, difluorovinylene carbonate, chlorovinylene carbonate, dichlorovinylene carbonate, bromovinylene carbonate, dibromovinylene carbonate, nitrovinylene ester, cyanovinylene carbonate, vinylene sulfonate, fluorovinylene sulfonate, difluorovinylene sulfonate, chlorovinylene sulfonate, dichlorovinylene sulfonate, bromovinylene carbonate, dibromovinylene sulfonate, nitrovinylene sulfonate, cyanovinylene sulfonate, vinylene phosphate, fluorovinylene phosphate, difluorovinylene phosphate, chlorovinylene phosphate, dichlorovinylene phosphate, bromovinylene phosphate, dibromovinylene phosphate, nitrovinylene phosphate, cyanovinylene phosphate, 4-vinyl-4-methyl-1,3-dioxolan-2-one, 4-vinyl-4-ethyl-1,3-dioxolan-2-one, 4-vinyl-4-propyl-1,3-dioxolan-2-one, 4-vinyl-5-methyl-1,3-dioxolan-2-one, 4-vinyl-5-ethyl-1,3-dioxolan-2-one, 4-vinyl-5-propyl-1,3-dioxolan-2-one, and unsaturated cyclic ester compound derivatives thereof with a partially halogenated or perhalogenated branched carbon chain or ether group having one to six carbon atoms.

Preferably, the unsaturated cyclic ester compound shown in formula (II) in the non-aqueous organic solvent accounts for 0.5-5% by mass.

The presence of the dinitrile compound shown in formula (III) can improve the service life of the lithium ion secondary battery under high-voltage conditions. Preferably, the dinitrile compound is one or more of the following: succinonitrile, glutaronitrile, adiponitrile, 1,5-dicyanopentane, 1,6-dicyanohexane, 1,7-dicyanoheptane, 1,8-dicyanooctane, 1,9-dicyanononane, 1,10-dicyanodecane, 1,12-dicyanododecane, tetramethylsuccinonitrile, 2-methylglutaronitrile, 2,4-dimethylglutaronitrile, 2,2,4,4-tetramethylglutaronitrile, 2,5-dimethyl-2,5-hexanedinitrile, 1,2-dicyanobenzene, 1,3-dicyanobenzene, 1,4-dicyanobenzene, and dinitrile derivatives of the above substances with halogenated, nitro substitution.

Preferably, the dinitrile compound in the non-aqueous organic solvent accounts for 0.5-10% by mass.

Preferably, in an embodiment of the present application the non-aqueous organic electrolyte further comprises lithium bis(oxalate)borate (LiBOB). More preferably, the lithium bis(oxalate)borate in the non-aqueous organic solvent accounts for 0.5-5% by mass.

The non-aqueous organic electrolyte provided in the embodiment of the present application has excellent chemical stability and electrochemical stability with a higher flash point, which can improve the interface stability between the electrolyte and the battery material, and can inhibit decomposition of the electrolyte solvent under a high voltage and aerogenic expansion of the lithium ion secondary battery at high temperature during storage, thereby improving high-temperature storage and safety performance of a high-voltage battery.

In the second aspect, an embodiment of the present application provides a lithium ion secondary battery, including:

a positive electrode, which includes a positive electrode active material capable of lithium ion intercalation or deintercalation, where the positive electrode active material is a mixture of a spinel structure material LiMnₓNiyO₄ and a laminated solid solution material zLi₂MnO₃*(1−z)LiMO₂ with a general formula expressed by

p(LiMnₓNi_{y}O₄)*q[zLi₂MnO₃*(1−z)LiMO₂]

(0<p<1, 0<q<1, p+q=1; 0<x<2, 0<y<1, x+y=2; 0<z<1, M may be Co or Ni);

a negative electrode, which includes a negative electrode active material capable of lithium ion intercalation or deintercalation; and

the non-aqueous organic electrolyte according to the first aspect of the embodiments of the present application.

The LiMnₓNi_{y}O₄ has a spinel structure and exhibits a high lithium ion deintercalation and intercalation platform during lithium ion deintercalation and intercalation at charge and discharge. The zLi₂MnO₃*(1−z)LiMO₂ is a manganides multi-mixed material with excellent stability. In the embodiment of the present application, the structure of the positive electrode active material is stable when the material is charged to a high potential of 4.8 V or above relative to the lithium potential. After the above non-aqueous organic electrolyte is arranged, the material has excellent high-temperature storage and safety performance when used under a high-voltage and full-charged condition. Therefore, the positive electrode active material has broad application prospects, and is especially important for the development of backup power energy storage.

In the third aspect, an embodiment of the present application provides a preparation method of the lithium ion secondary battery in the above second aspect, including the following steps:

(1) preparing a non-aqueous organic electrolyte:

mixing γ-butyrolactone with a saturated cyclic ester compound shown in formula (I) to produce a non-aqueous organic solvent, adding an unsaturated cyclic ester compound shown in formula (II) and a dinitrile compound shown in formula (III), and then adding a lithium salt to obtain the non-aqueous organic electrolyte of the lithium ion secondary battery, where

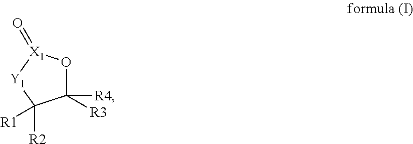

where X₁ is selected from a C, S or P group, Y₁ is selected from an O, CH2 or CH2CH2 group, and R1, R2, R3 and R4 are independently selected from hydrogen, halogen, cyano, nitro and a partially halogenated or perhalogenated carbon chain or ether group having one to six carbon atoms;

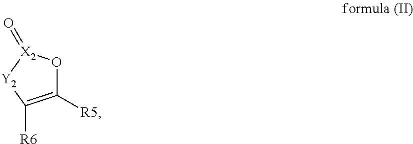

where X₂ is selected from a C or S group, Y₂ is selected from an O, CH2 or CH2CH2 group, and R5 and R6 are independently selected from hydrogen, halogen, cyano, nitro and a partially halogenated or perhalogenated carbon chain or ether group having one to six carbon atoms; and

NC—R7-CN formula (III),

where R7 is a hydrocarbyl or hydrocarbyl derivative having one to fifteen carbon atoms;

(2) producing a battery electrode core from a positive electrode, a negative electrode and a membrane, and injecting the non-aqueous organic electrolyte to obtain the lithium ion secondary battery, where

the positive electrode includes a positive electrode active material capable of lithium ion intercalation or deintercalation, where the positive electrode active material is a mixture of a spinel structure material LiMnₓNiyO₄ and a laminated solid solution material zLi₂MnO₃*(1−z)LiMO₂ with a general formula expressed by

p(LiMnₓNi_{y}O₄)*q[zLi₂MnO₃*(1−z)LiMO₂]

(0<p<1, 0<q<1, p+q=1; 0<x<2, 0<y<1, x+y=2; 0<z<1, M may be Co or Ni); and

the negative electrode includes a negative electrode active material capable of lithium ion intercalation or deintercalation.

The preparation method of the lithium ion secondary battery is simple and feasible.

In a fourth aspect, an embodiment of the present application provides a terminal communication device containing the lithium ion secondary battery in the above second aspect, including a communication module and the lithium ion secondary battery in the above second aspect, where the communication module is configured to implement a communication function, and the lithium ion secondary battery is configured to provide power supply for the communication module.

The lithium ion secondary battery in the terminal communication device has high energy storage and backup power performance, which is specifically demonstrated by high energy density and long-time storage under a full-charged condition.

Advantages of the embodiments of the present application may be partially clarified in the following description. A part of the advantages are apparent according to the description, or may be learned from implementation of the embodiments of the present application.

### DESCRIPTION OF EMBODIMENTS

Following are some preferred embodiments of the present application. It should be noted that various improvements and modifications can be made without departing from the principle of the embodiments of the present application for those of ordinary skill in the art, and such improvements and modifications shall all fall within the protection scope of the embodiments of the present application.

Usually, in a high-voltage charged battery system, side reactions tend to occur on an electrode surface in an electrolyte, in particular, oxidation decomposition reactions of a non-aqueous organic electrolyte on a positive electrode active material, and decomposition of an organic solid electrolyte interface (SEI) film covering a carbon negative electrode surface of a lithium ion secondary battery due to electrochemical energy and thermal energy, result in side reactions between a carbonate solvent in the non-aqueous organic electrolyte and the carbon negative electrode surface exposed due to the damage of the SEI film, and gases generated during the side reactions cause increased pressure inside the lithium ion secondary battery, resulting in battery expansion, severe deterioration of battery performance, and even inability to work normally with failure of the battery.

To solve the above problems, an embodiment of the present application provides a non-aqueous organic electrolyte. The non-aqueous organic electrolyte in the embodiment of the present application has excellent chemical stability and electrochemical stability with a higher flash point, which can improve the interface stability between the electrolyte and a battery material, and can inhibit decomposition of an electrolyte solvent under a high voltage and aerogenic expansion of a lithium ion secondary battery at high temperature during storage, thereby improving high-temperature storage and safety performance of a high-voltage battery.

Specifically, the non-aqueous organic electrolyte provided in the embodiment of the present application includes:

(1) A lithium salt, which, as a carrier, is used to ensure basic operation of lithium ions in a lithium ion secondary battery. The lithium salt is selected from one or more of the following: LiPF₆, LiBF₄, LiSbF₆, LiClO₄, LiCF₃SO₃, LiAlO₄, LiAlCl₄, Li(CF₃SO₂)₂N, LiBOB and LiDFOB. A final concentration of the lithium salt in the non-aqueous organic electrolyte is 0.5-1.5 mol/L. The lithium salt functions better when its final concentration in the non-aqueous organic electrolyte is 0.9 mol/L.

(2) A non-aqueous organic solvent: the non-aqueous organic solvent includes γ-butyrolactone (GBL) and a saturated cyclic ester compound shown in formula (I), and is used to dissolve the lithium salt.

γ-butyrolactone (GBL) is a strong protic solvent which can dissolve a majority of low molecular polymers and a part of high molecular polymers. The aerogenesis of a reduction product of γ-butyrolactone is low and thickness expansion is not obvious, and therefore the battery presents obvious advantages in high-temperature storage performance.

The saturated cyclic ester compound shown in formula (I) is as follows:

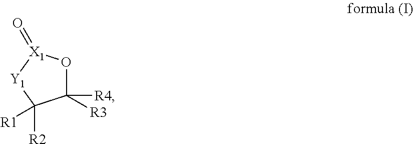

where X₁ is selected from a C, S or P group, Y₁ is selected from an O, CH2 or CH2CH2 group, and R1, R2, R3 and R4 are independently selected from hydrogen, halogen, cyano, nitro and a partially halogenated or perhalogenated carbon chain or ether group having one to six carbon atoms.

The saturated cyclic ester compound shown in formula (I) is a 5-membered cyclic ester compound when Y₁ is selected from an O or CH2 group. The saturated cyclic ester compound shown in formula (I) is a 6-membered cyclic ester compound when Y₁ is selected from a CH2CH2 group.

The saturated cyclic ester compound shown in formula (I) is one or more of the following: Ethylene Carbonate (Ethylene Carbonate, abbreviated as EC), Propylene Carbonate (Propylene Carbonate, abbreviated as PC), ethyl sulfonate, propyl sulfonate, ethyl phosphate, propyl phosphate, fluoroethylene carbonate (FEC), fluoropropylene carbonate, difluoropropylene carbonate, trifluoropropylene glycol ester, fluoro-γ-butyrolactone, difluoro-γ-butyrolactone, chloropropylene carbonate, dichloropropylene carbonate, trichloropropylene glycol ester, chloro-γ-butyrolactone, dichloro-γ-butyrolactone, bromopropylene carbonate, dibromopropylene carbonate, tribromopropylene glycol ester, bromo-γ-butyrolactone, dibromo-γ-butyrolactone, nitropropylene carbonate, nitro-γ-butyrolactone, cyanopropylene carbonate, cyano-γ-butyrolactone, fluoroethyl sulfonate, fluoropropylene sulfonate, difluoropropylene sulfonate, trifluoropropylene sulfonate, fluoro-γ-butyrolactone sulfonate, difluoro-γ-butyrolactone sulfonate, chloropropylene sulfonate, dichloropropylene sulfonate, trichloropropylene sulfonate, chloro-γ-butyrolactone sulfonate, dichloro-γ-butyrolactone sulfonate, bromopropylene sulfonate, dibromopropylene sulfonate, tribromopropylene sulfonate, bromo-γ-butyrolactone sulfonate, dibromo-γ-butyrolactone sulfonate, nitropropylene sulfonate, nitro-γ-butyrolactone sulfonate, cyanopropylene sulfonate, cyano-γ-butyrolactone sulfonate, fluoroethyl phosphate, fluoropropylene phosphate, difluoropropylene phosphate, trifluoropropylene phosphate, fluoro-γ-butyrolactone phosphate, difluoro-γ-butyrolactone phosphate, chloropropylene phosphate, dichloropropylene phosphate, trichloropropylene phosphate, chloro-γ-butyrolactone phosphate, dichloro-γ-butyrolactone phosphate, bromopropylene phosphate, dibromopropylene phosphate, tribromopropylene phosphate, bromo-γ-butyrolactone phosphate, dibromo-γ-butyrolactone phosphate, nitropropylene phosphate, nitro-γ-butyrolactone phosphate, cyanopropylene phosphate, cyano-γ-butyrolactone phosphate, and saturated cyclic ester compound derivatives of the above substances with a partially halogenated or perhalogenated branched carbon chain or ethers groups having one to six carbon atoms.

For example, the saturated cyclic ester compound shown in formula (I) is ethylene carbonate (Ethylene Carbonate, abbreviated as EC) and propylene carbonate (Propylene Carbonate, abbreviated as PC), and has a high dielectric constant. Also for example, the saturated cyclic ester compound shown in formula (I) is fluoroethylene carbonate (FEC). With a high flash point of fluoroethylene carbonate and flame-retardant effect of the fluorine element, battery safety can be improved. Fluoroethylene carbonate has excellent film-forming performance as well.

The saturated cyclic ester compound shown in formula (I) in the non-aqueous organic solvent accounts for 5-50% by volume.

The γ-butyrolactone (GBL) and the saturated cyclic ester compound shown in formula (I) are mixed into the non-aqueous organic solvent. A volume ratio of the γ-butyrolactone (GBL) to the saturated cyclic ester compound shown in formula (I) in the non-aqueous organic solvent is 1-10:1.

(3) An unsaturated cyclic ester compound shown in formula (II):

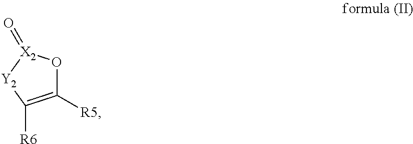

where X₂ is selected from a C or S group, Y₂ is selected from an O, CH2 or CH2CH2 group, and R5 and R6 are independently selected from hydrogen, halogen, cyano, nitro and a partially halogenated or perhalogenated carbon chain or ether group having one to six carbon atoms.

The unsaturated cyclic ester compound shown in formula (II) is an unsaturated 5-membered cyclic ester compound when Y₂ is selected from an O or CH2 group. The unsaturated cyclic ester compound shown in formula (II) is an unsaturated 6-membered cyclic ester compound when Y₂ is selected from a CH2CH2 group.

The unsaturated cyclic ester compound shown in formula (II) is one or more of the following: vinylene carbonate (Vinylene Carbonate, abbreviated as VC), fluorovinylene carbonate, difluorovinylene carbonate, chlorovinylene carbonate, dichlorovinylene carbonate, bromovinylene carbonate, dibromovinylene carbonate, nitrovinylene ester, cyanovinylene carbonate, vinylene sulfonate, fluorovinylene sulfonate, difluorovinylene sulfonate, chlorovinylene sulfonate, dichlorovinylene sulfonate, bromovinylene carbonate, dibromovinylene sulfonate, nitrovinylene sulfonate, cyanovinylene sulfonate, vinylene phosphate, fluorovinylene phosphate, difluorovinylene phosphate, chlorovinylene phosphate, dichlorovinylene phosphate, bromovinylene phosphate, dibromovinylene phosphate, nitrovinylene phosphate, cyanovinylene phosphate, 4-vinyl-4-methyl-1,3-dioxolan-2-one, 4-vinyl-4-ethyl-1,3-dioxolan-2-one, 4-vinyl-4-propyl-1,3-dioxolan-2-one, 4-vinyl-5-methyl-1,3-dioxolan-2-one, 4-vinyl-5-ethyl-1,3-dioxolan-2-one, 4-vinyl-5-propyl-1,3-dioxolan-2-one, and unsaturated cyclic ester compound derivatives thereof with a partially halogenated or perhalogenated branched carbon chain or ethers groups having one to six carbon atoms. For example, vinylene carbonate can significantly improve performance of an organic solid electrolyte interface (SEI) film, and further improve charge-discharge efficiency and cycle characteristics of the lithium ion secondary battery.

The unsaturated cyclic ester compound shown in formula (II) in the non-aqueous organic solvent accounts for 0.5-5% by mass.

(4) A dinitrile compound shown in formula (III):

NC—R7-CN formula (III),

where R7 is a hydrocarbyl or hydrocarbyl derivative having one to fifteen carbon atoms.

Under a high-voltage condition, the dinitrile compound shown in formula (III) can react with the surface of the positive electrode active material of the lithium ion secondary battery to make the positive electrode structure containing the positive electrode active material stable, so as to inhibit side reactions between the positive electrode surface and the non-aqueous organic electrolyte, thereby improving the service life of the lithium ion secondary battery under a high-voltage condition. The dinitrile compound is one or more of the following: succinonitrile, glutaronitrile, adiponitrile, 1,5-dicyanopentane, 1,6-dicyanohexane, 1,7-dicyanoheptane, 1,8-dicyanooctane, 1,9-dicyanononane, 1,10-dicyanodecane, 1,12-dicyanododecane, tetramethylsuccinonitrile, 2-methylglutaronitrile, 2,4-dimethylglutaronitrile, 2,2,4,4-tetramethylglutaronitrile, 2,5-dimethyl-2,5-hexanedinitrile, 1,2-dicyanobenzene, 1,3-dicyanobenzene, 1,4-dicyanobenzene, and dinitrile derivatives of the above substances with halogenated, nitro substitution.

The dinitrile compound in the non-aqueous organic solvent accounts for 0.5-10% by mass.

Desired performance of the non-aqueous organic electrolyte can be obtained by adjusting amount ratios of the lithium salt, the non-aqueous organic solvent, the unsaturated cyclic ester compound shown in formula (II) and the dinitrile compound shown in formula (III) in the non-aqueous organic electrolyte.

In an embodiment of the present application, the non-aqueous organic electrolyte further includes lithium bis(oxalate)borate (LiBOB). Lithium bis(oxalate)borate has unique film-forming performance and stability to electrode materials, and especially can form a stable and dense organic solid electrolyte interface (SEI) film on the surface of the negative electrode. In addition, lithium bis(oxalate)borate has good thermal stability and can exist stably until 300° C., and, in comparison with a commonly used lithium salt LiPF₆, has no fluorine ion, and therefore may not decompose to generate HF gases. The lithium bis(oxalate)borate in the non-aqueous organic solvent accounts for 0.5-5% by mass.

In a second aspect, an embodiment of the present application provides a lithium ion secondary battery, including the non-aqueous organic electrolyte described in the first aspect of the embodiments of the present application. Specifically, the lithium ion secondary battery provided in the embodiment of the present application includes:

a positive electrode, which includes a positive electrode active material capable of lithium ion intercalation or deintercalation, where the positive electrode active material is a mixture of a spinel structure material LiMnₓNiyO₄ and a laminated solid solution material zLi₂MnO₃*(1−z)LiMO₂ with a general formula expressed by

p(LiMnₓNi_{y}O₄)*q[zLi₂MnO₃*(1−z)LiMO₂]

(0<p<1, 0<q<1, p+q=1; 0<x<2, 0<y<1, x+y=2; 0<z<1, M may be Co or Ni); and

a negative electrode, which includes a negative electrode active material capable of lithium ion intercalation or deintercalation,

for example, the non-aqueous organic electrolyte described in the first aspect of the embodiments of the present application.

The LiMnₓNi_{y}O₄ (0<x<2, 0<y<1, x+y=2) in the positive electrode active material has a spinel structure and exhibits a high lithium ion deintercalation and intercalation platform during lithium ion deintercalation and deintercalation at charge and discharge. The zLi₂MnO₃*(1−z)LiMO₂ (0<z<1, M may be Co or Ni) is a manganides multi-mixed material with excellent stability, consisting of Li₂MnO₃ and LiMO₂.

Before formulation and slurry-making for the positive electrode active material, LiMnₓNi_{y}O₄ (0<x<2, 0<y<1, x+y=2) and zLi₂MnO₃*(1−z)LiMO₂ (0<z<1, M may be Co or Ni) need to be mixed evenly, and usually, solid phase ball milling is used to achieve even dispersion or a round or V-shape rotary mixer is used to achieve the dispersion. Even dispersion by solid phase ball milling means that two solid active materials with different structures are added into a ball milling jar according to a given ratio, and then zirconium balls are added, and a ball milling dispersing machine is utilized to achieve even dispersion.

The structure of the positive electrode active material is stable when the material is charged to a high potential of 4.8 V or above relative to the lithium potential. After the non-aqueous organic electrolyte described in the first aspect of the embodiments of the present application is arranged, the material has excellent high-temperature storage and safety performance when used under a high-voltage and full-charged condition. Therefore, the positive electrode active material has broad application prospects, and is especially important for the development of backup power energy storage.

The negative electrode includes a negative electrode active material capable of lithium ion intercalation or deintercalation. Specifically, the negative electrode active material may be one or more of the following: lithium metal, silicon materials, tin materials, alloy materials, or carbon materials such as natural graphite, artificial graphite, mesophase carbon microsphere, carbon nanotube, carbon fiber, graphene composite materials and silicon-carbon composite materials.

The non-aqueous organic electrolyte includes:

(1) a lithium salt;

(2) a non-aqueous organic solvent, where the non-aqueous organic solvent includes γ-butyrolactone and a saturated cyclic ester compound shown in formula (I),

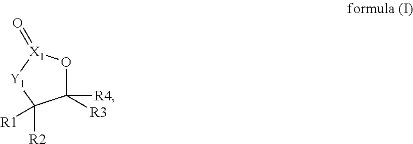

where X₁ is selected from a C, S or P group, Y₁ is selected from an O, CH2 or CH2CH2 group, and R1, R2, R3 and R4 are independently selected from hydrogen, halogen, cyano, nitro and a partially halogenated or perhalogenated carbon chain or ether group having one to six carbon atoms;

(3) an unsaturated cyclic ester compound shown in formula (II),

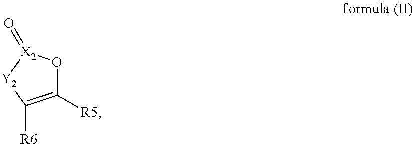

where X₂ is selected from a C or S group, Y₂ is selected from an O, CH2 or CH2CH2 group, and R5 and R6 are independently selected from hydrogen, halogen, cyano, nitro and a partially halogenated or perhalogenated carbon chain or ether group having one to six carbon atoms; and

(4) a dinitrile compound shown in formula (III),

NC—R7-CN formula (III),

where R7 is a hydrocarbyl or hydrocarbyl derivative having one to fifteen carbon atoms.

The non-aqueous organic electrolyte is specifically the same as aforesaid.

The form of the lithium ion secondary battery in the embodiment of the present application is not limited. The lithium ion secondary battery may be a square, cylindrical or soft pack battery, either coiled or stacked.

In a third aspect, an embodiment of the present application provides a preparation method of a lithium ion secondary battery, where the lithium ion secondary battery includes the non-aqueous organic electrolyte described in the first aspect of the embodiments of the present application.

Hereinafter, the preparation method of a lithium ion secondary battery in the embodiment of the present application may be described by taking the production of a square coiled soft pack lithium ion secondary battery (model 423450) as an example.

Preparation of a Positive Electrode Plate

In the embodiment of the present application, a selected positive electrode active material is a material of LiMn_{1.5}Ni_{0.5}O₄ and 0.5Li₂MnO₃*0.5LiNiO₂ mixed at a mass ratio of 9:1, and before formulation, the mixture is dispersed evenly by using solid phase ball milling. Then, the dispersed positive electrode active material, a conductive agent carbon black powder material and a binder PVDF powder material are mixed at a mass ratio of 85:10:5, and then, an N-methylpyrrolidone (NMP) solution is added to prepare as an oil-based slurry. Finally, the slurry is coated on both sides of an aluminum current collector, to prepare a positive electrode plate of the lithium ion secondary battery.

Preparation of a Negative Electrode Plate

A negative electrode active material artificial graphite powder, a binder carboxymethylcellulose (CMC), a binder styrene-butadiene rubber (SBR) emulsion are mixed at a mass ratio of 100:3:2, and then deionized water is added to prepare as an water-based negative electrode slurry. Finally, the slurry is coated on both sides of a copper current collector, to prepare a negative electrode plate of the lithium ion secondary battery. The capacity of the negative electrode plate is designed to 1.2 times that of the positive electrode plate.

Preparation of the Non-Aqueous Organic Electrolyte

A non-aqueous organic solvent γ-butyrolactone (GBL), fluoroethylene carbonate (FEC) and propylene carbonate (PC) are mixed at a volume ratio of 85:10:5 to produce a non-aqueous organic solvent, and then dinitrile compound NC—R7-CN (R7 is a hydrocarbyl or hydrocarbyl derivative having one to fifteen carbon atoms), vinylene carbonate (VC), and bis(oxalate)borate (LiBOB) at different mass ratios (relative to the mass of the non-aqueous organic solvent) are added. Finally, a proper lithium salt is added to formulate a desired concentration, to obtain the non-aqueous organic electrolyte of the lithium ion secondary battery.

Production of the Lithium Ion Secondary Battery

A composite membrane consisting of polypropylene and polyethylene is placed between the positive electrode plate and the negative electrode plate prepared above, like a sandwich structure, then they are coiled into a model 423450 square battery electrode core, then, a square coiled soft pack battery is completed, and finally the non-aqueous organic electrolyte is injected to obtain a high-voltage lithium ion secondary battery.

Using the above preparation method of a lithium ion secondary battery can achieve the same effect for a lithium ion secondary battery, no matter whether it is a square, cylindrical or soft pack battery, or no matter whether it is coiled or stacked.

In a fourth aspect, an embodiment of the present application provides a terminal communication device containing the lithium ion secondary battery in the above second aspect, which includes a communication module and the lithium ion secondary battery in the above second aspect, where the communication module is configured to implement a communication function, and the lithium ion secondary battery is configured to provide power supply for the communication module.

The lithium ion secondary battery in the terminal communication device has high energy storage and backup power performance, which is specifically demonstrated by high energy density and long-time storage under a full-charged condition.

Hereinafter, the present application are further described through several embodiments by taking the production and testing of a square coiled soft pack lithium ion secondary battery (model 423450) as an example. The present application are not limited to the following specific embodiments. Appropriate modifications can be implemented within the scope of the independent claims.

### Embodiment 1

A non-aqueous organic solvent γ-butyrolactone (GBL), fluoroethylene carbonate (FEC) and propylene carbonate (PC) are mixed at a volume ratio of 85:10:5 to produce a non-aqueous organic solvent, and then 0.1% (Wt) glutaronitrile is added to the non-aqueous organic solvent, followed by 2% (Wt) vinylene carbonate (VC), and finally a certain mass of lithium salt LiPF₆ is added to obtain a non-aqueous organic electrolyte at a formulated concentration of 0.9 mol/L. The formulated non-aqueous organic electrolyte is injected into the aforesaid square coiled soft pack battery to obtain Embodiment 1 of the present application.

### Embodiment 2

Embodiment 2 is based on Embodiment 1 with a difference that the amount of glutaronitrile in the formulated non-aqueous organic electrolyte is 1% (Wt) to obtain Embodiment 2 of the present application.

### Embodiment 3

Embodiment 3 is based on Embodiment 1 with a difference that the amount of glutaronitrile in the formulated non-aqueous organic electrolyte is 3% (Wt) to obtain Embodiment 3 of the present application.

### Embodiment 4

Embodiment 4 is based on Embodiment 1 with a difference that the amount of glutaronitrile in the formulated non-aqueous organic electrolyte is 5% (Wt) to obtain Embodiment 4 of the present application.

### Embodiment 5

Embodiment 5 is based on Embodiment 1 with a difference that the amount of glutaronitrile in the formulated non-aqueous organic electrolyte is 10% (Wt) to obtain Embodiment 5 of the present application.

### Embodiment 6

Embodiment 6 is based on Embodiment 3 with a difference that 2% (Wt) lithium bis(oxalate)borate (LiBOB) is further added to obtain Embodiment 6 of the present application.

### Comparative Embodiment 1

A traditional electrolyte is used. Ethylene carbonate (EC), ethyl methyl carbonate (EMC), dimethyl carbonate (DMC) are mixed at a volume ratio of 1:1:1 to produce a non-aqueous organic solvent, then a certain mass of lithium salt LiPF₆ is added to the non-aqueous organic solvent to obtain an electrolyte at a formulated concentration of 0.9 M/L. The above electrolyte is injected into the aforesaid square coiled soft pack battery to obtain Comparative Embodiment 1.

### Comparative Embodiment 2

As described in Comparative Embodiment 1, a difference is that 2% (Wt) vinylene carbonate (VC) is further added to the electrolyte used in Comparative Embodiment 1 to obtain Comparative Embodiment 2.

### Comparative Embodiment 3

As described in Comparative Embodiment 1, a difference is that 2% (Wt) vinylene carbonate (VC) and 3% (Wt) glutaronitrile are further added to the electrolyte used in Comparative Embodiment 1 to obtain Comparative Embodiment 3.

The percentages mentioned in the above Embodiments and Comparative Embodiments are mass percentages, and specifically the percentage of the added mass of each component in the mass of the non-aqueous organic solvent.

The lithium ion secondary batteries obtained in the above Embodiments and Comparative Embodiments are experimental batteries used for performance testing in the following Effect Embodiment.

### Effect Embodiment

To provide strong support for the beneficial effects brought by the technical solutions of the embodiments of the present application, the following performance tests are provided:

1. Safety Performance Test

The experimental batteries in Embodiments 1-6 and Comparative Embodiments 1-3 are charged with a 1 C constant current by using a lithium battery overcharged testing cabinet to an upper limit of 4.8 V. After being charged with a 4.8V constant voltage for 2 hours, the batteries are left at room temperature for 1 hour, and then overcharged with 1 C to 10V. Whether smoke, fire, burning, explosion or the like occurs to the batteries during the overcharging is recorded. The batteries in the Embodiments and Comparative Embodiments which have been left at room temperature for 1 hour and in 4.8V fully charged state are placed on an iron wire mesh with a protective device outside, and a liquefied gas flame is used to heat directly under the battery. Whether smoke, fire, burning, explosion or the like occurred to the batteries during the burning test is recorded. Test results are shown in Table 1.

2. High-Temperature Storage Performance Test

The batteries in the Embodiments and Comparative Embodiments which have been left at room temperature for 1 hour and in 4.8V fully charged state are placed in a cabinet at the high temperature of 60° C. for 10 days. Thicknesses of the batteries in the embodiments are measured before and after storage, and thickness growth rates are calculated by comparing the battery thicknesses after high-temperature storage with the battery thicknesses before high-temperature storage. In addition, the batteries which have been stored at high temperature for 10 days are left at 35° C. for 5 hours, then discharged at 35° C. constantly with a 1 C constant current to 3.0 V, then charged with a 1 C constant current to 4.8 V, kept at the voltage constantly for 2 hours, and finally discharged at a 1 C constant current to 3.0 V. The capacity recovery rates after high-temperature storage of the Embodiments and Comparative Embodiments are calculated, with results shown in Table 1. The capacity recovery rate after high-temperature storage refers in particular to a ratio of discharge capacity of a battery at specific temperature after high-temperature storage to discharge capacity of the battery at specific temperature before high-temperature storage.

TABLE 1
Performance tests of experimental batteries in Embodiments 1-6 and Comparative Embodiments 1-3

| | | | | | | Thickness | Capacity |
|---|---|---|---|---|---|---|---|
| | | | | | | change rate | recovery rate |
| | Additive | Additive | Additive | Test | Burning | after high- | after high- |
| | amount of | amount | amount | result at | test | temperature | temperature |
| | glutaronitrile/% | of VC/% | of LiBOB/% | 1C-10V | result | storage | storage |
| Embodiment 1 | 0.1 | 2 | — | No explosion | Smoke | 7% | 81% |
| Embodiment 2 | 1 | 2 | — | No explosion | Smoke | 7% | 82% |
| Embodiment 3 | 3 | 2 | — | No explosion | Smoke | 7% | 85% |
| Embodiment 4 | 5 | 2 | — | No explosion | Smoke | 7% | 85% |
| Embodiment 5 | 10 | 2 | — | No explosion | Smoke | 7% | 81% |
| Embodiment 6 | 3 | 2 | 2 | No explosion | Smoke | 5% | 87% |
| Comparative | — | — | — | Explosion | Explosion | 57% | 27% |
| Embodiment 1 | | | | | | | |
| Comparative | — | 2 | — | Explosion | Explosion | 31% | 41% |
| Embodiment 2 | | | | | | | |
| Comparative | 3 | 2 | — | Explosion | Explosion | 18% | 67% |
| Embodiment 3 | | | | | | | |

It can be known from the test results shown in Table 1 that the high-voltage-endurable non-aqueous organic electrolyte battery systems provided in the embodiments of the present application have better safety and stability compared with traditional electrolyte batteries in the high-voltage overcharge test and burning test. Containing a large amount of straight-chain solvent dimethyl carbonate (DMC) and ethyl methyl carbonate (EMC), the electrolyte used in the Comparative Embodiments is prone to combustion and explosion in the overcharge test and burning test because of low flash points of DMC and EMC. The non-aqueous organic electrolyte solvent provided in the embodiments of the present application, however, has a high flash point, and demonstrates good safety and stability in the overcharge test and burning test.

The test results of Comparative Embodiments 1, 2 and 3 show that the high-temperature storage performance of the batteries using traditional electrolytes is poor with serious battery expansion. In Comparative Embodiment 1, the recovered capacity of the battery after high-temperature storage at a 4.8V high voltage in fully charged state suffers a serious loss, and the experimental battery even cannot be charged or discharged normally. This is mainly because the antioxidation of traditional electrolytes is poor, and in particular, an oxidation reaction easily occurs on the surface of the positive electrode at a high potential, resulting in a large irreversible capacity loss. In addition, a traditional electrolyte tends to reductive decomposing constantly on the surface of the negative electrode, and the reduction product is attached to the surface of the negative electrode. A thick reduction product layer can easily cause a larger battery impedance, and the layer of reduction product is unstable at high temperature, which causes some loss of battery capacity.

Compared with Comparative Embodiment 1, in Comparative Embodiment 2, vinylene carbonate (VC) is added to the electrolyte, and the high-temperature recovery capacity of the battery is increased. This is mainly because vinylene carbonate (VC) can form a stable protective film on the surface of the negative electrode, which further reduces decomposition of the solvent on the negative electrode. But, at a high potential, there is still solvent redox and serious battery expansion, and therefore deterioration of high-temperature storage capacity is still serious.

In Comparative Embodiment 3, glutaronitrile compound is added. Compared with a situation where glutaronitrile is not added, recovery of capacity after high-temperature storage is obvious, which can improve high-voltage performance of the traditional electrolyte.

In the Embodiments 1-6, the non-aqueous organic electrolyte provided in the embodiments of the present application is used, where a weak oxidative solvent is mainly used, which exhibit excellent high-voltage performance to meet requirements of a high-energy battery for a high-voltage electrolyte. The aerogenesis of the reduction product of γ-butyrolactone (GBL) is low and thickness expansion is not obvious, and therefore the battery presents obvious advantages in high-temperature storage performance. With the high flash point of fluoroethylene carbonate (FEC) and the flame-retardant effect of the fluorine element, battery safety can be improved, and fluoroethylene carbonate (FEC) has excellent film-forming performance as well. However, when used in a large amount, fluoroethylene carbonate tends to deteriorate battery capacity, and particularly, when in high-temperature storage, tends to decompose to decomposed gas and fluorinated acid, thereby damaging the protective film on the surface of the negative electrode material and causing serious battery expansion. In addition, different masses of glutaronitrile solvents are used in the Embodiments 1-6. The test results show that the additive amount of glutaronitrile needs to be controlled between 3% and 5%. With a small quantity, performance cannot be improved, while with a larger quantity, it is likely to cause side reactions and deteriorate battery performance.

As an excellent high-temperature film-forming additive, lithium bis(oxalate)borate (LiBOB) can form a good protective film on the surface of the negative electrode material. The protective film has good stability at high temperature and is hard to break or fall off from the surface of the negative electrode, thereby protecting the electrolyte and the surface of the negative electrode material effectively. The protective effect is better when LiBOB is used in conjunction with vinylene carbonate (VC), which greatly increases the use amounts of glutaronitrile solvents and fluoroethylene carbonate (FEC).

What is claimed is:

1. A non-aqueous organic electrolyte, comprising
(1) a lithium salt;
(2) a non-aqueous organic solvent, wherein the non-aqueous organic solvent comprises γ-butyrolactone and a saturated cyclic ester compound of formula (I), 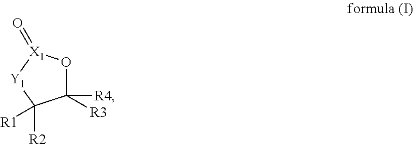
wherein X₁ is a C, S or P group, Y₁ is O, CH₂ or CH₂CH₂, and R1, R2, R3 and R4 are independently hydrogen, halogen, cyano, nitro, a haloalkyl or perhaloalkyl, or a C₁-C₆ alkoxy;
(3) an unsaturated cyclic ester compound shown in formula (II), 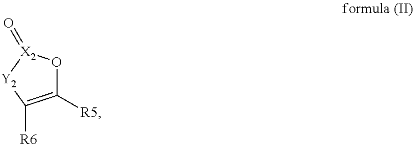
wherein X₂ is a C or S group, Y₂ is O, CH₂ or CH₂CH₂, and R5 and R6 are independently hydrogen, halogen, cyano, nitro, a haloalkyl or perhaloalkyl, or C₁-C₆ alkoxy; and
(4) a dinitrile compound shown in formula (III),
NC—R7-CN formula (III),
wherein R7 is a hydrocarbyl having one to fifteen carbon atoms.

2. The non-aqueous organic electrolyte according to claim 1, wherein the saturated cyclic ester compound of formula (I) is one or more of the following: ethylene carbonate, propylene carbonate, ethyl sulfonate, propyl sulfonate, ethyl phosphate, propyl phosphate, fluoroethylene carbonate, fluoropropylene carbonate, difluoropropylene carbonate, trifluoropropylene glycol ester, fluoro-γ-butyrolactone, difluoro-γ-butyrolactone, chloropropylene carbonate, dichloropropylene carbonate, trichloropropylene glycol ester, chloro-γ-butyrolactone, dichloro-γ-butyrolactone, bromopropylene carbonate, dibromopropylene carbonate, tribromopropylene glycol ester, bromo-γ-butyrolactone, dibromo-γ-butyrolactone, nitropropylene carbonate, nitro-γ-butyrolactone, cyanopropylene carbonate, cyano-γ-butyrolactone, fluoroethyl sulfonate, fluoropropylene sulfonate, difluoropropylene sulfonate, trifluoropropylene sulfonate, fluoro-γ-butyrolactone sulfonate, difluoro-γ-butyrolactone sulfonate, chloropropylene sulfonate, dichloropropylene sulfonate, trichloropropylene sulfonate, chloro-γ-butyrolactone sulfonate, dichloro-γ-butyrolactone sulfonate, bromopropylene sulfonate, dibromopropylene sulfonate, tribromopropylene sulfonate, bromo-γ-butyrolactone sulfonate, dibromo-γ-butyrolactone sulfonate, nitropropylene sulfonate, nitro-γ-butyrolactone sulfonate, cyanopropylene sulfonate, cyano-γ-butyrolactone sulfonate, fluoroethyl phosphate, fluoropropylene phosphate, difluoropropylene phosphate, trifluoropropylene phosphate, fluoro-γ-butyrolactone phosphate, difluoro-γ-butyrolactone phosphate, chloropropylene phosphate, dichloropropylene phosphate, trichloropropylene phosphate, chloro-γ-butyrolactone phosphate, dichloro-γ-butyrolactone phosphate, bromopropylene phosphate, dibromopropylene phosphate, tribromopropylene phosphate, bromo-γ-butyrolactone phosphate, dibromo-γ-butyrolactone phosphate, nitropropylene phosphate, nitro-γ-butyrolactone phosphate, cyanopropylene phosphate, cyano-γ-butyrolactone phosphate.

3. The non-aqueous organic electrolyte according to claim 1, wherein the non-aqueous organic solvent comprises 5-50% by volume of the saturated cyclic ester compound of formula (I).

4. The non-aqueous organic electrolyte according to claim 1, wherein the non-aqueous organic solvent comprises γ-butyrolactone and the saturated cyclic ester compound of formula (I) in a volume ratio of 1:1 to 10:1.

5. The non-aqueous organic electrolyte according to claim 1, wherein the unsaturated cyclic ester compound shown in formula (II) is one or more of the following: vinylene carbonate, fluorovinylene carbonate, difluorovinylene carbonate, chlorovinylene carbonate, dichlorovinylene carbonate, bromovinylene carbonate, dibromovinylene carbonate, nitrovinylene ester, cyanovinylene carbonate, vinylene sulfonate, fluorovinylene sulfonate, difluorovinylene sulfonate, chlorovinylene sulfonate, dichlorovinylene sulfonate, bromovinylene carbonate, dibromovinylene sulfonate, nitrovinylene sulfonate, cyanovinylene sulfonate, vinylene phosphate, fluorovinylene phosphate, difluorovinylene phosphate, chlorovinylene phosphate, dichlorovinylene phosphate, bromovinylene phosphate, dibromovinylene phosphate, nitrovinylene phosphate, cyanovinylene phosphate, 4-vinyl-4-methyl-1,3-dioxolan-2-one, 4-vinyl-4-ethyl-1,3-dioxolan-2-one, 4-vinyl-4-propyl-1,3-dioxolan-2-one, 4-vinyl-5-methyl-1,3-dioxolan-2-one, 4-vinyl-5-ethyl-1,3-dioxolan-2-one, 4-vinyl-5-propyl-1,3-dioxolan-2-one.

6. The non-aqueous organic electrolyte according to claim 1, wherein the unsaturated cyclic ester compound shown in formula (II) in the non-aqueous organic solvent accounts for 0.5-5% by mass of the total mass of the non-aqueous organic solvent.

7. The non-aqueous organic electrolyte according to claim 1, wherein the dinitrile compound is one or more of the following: succinonitrile, glutaronitrile, adiponitrile, 1,5-dicyanopentane, 1,6-dicyanohexane, 1,7-dicyanoheptane, 1,8-dicyanooctane, 1,9-dicyanononane, 1,10-dicyanodecane, 1,12-dicyanododecane, tetramethylsuccinonitrile, 2-methylglutaronitrile, 2,4-dimethylglutaronitrile, 2,2,4,4-tetramethylglutaronitrile, 2,5-dimethyl-2,5-hexanedinitrile, 1,2-dicyanobenzene, 1,3-dicyanobenzene, 1,4-dicyanobenzene, and dinitrile derivatives of the above substances with halogenated, nitro substitution.

8. The non-aqueous organic electrolyte according to claim 1, wherein the dinitrile compound in the non-aqueous organic solvent accounts for 0.5-10% by mass of the total mass of the non-aqueous organic solvent.

9. The non-aqueous organic electrolyte according to claim 1, wherein the non-aqueous organic electrolyte further comprises lithium bis(oxalate)borate.

10. The non-aqueous organic electrolyte according to claim 9, wherein the lithium bis(oxalate)borate in the non-aqueous organic solvent accounts for 0.5-5% by mass of the total mass of the non-aqueous organic solvent.

11. A lithium ion secondary battery, comprising
a positive electrode, wherein the positive electrode comprises a positive electrode active material capable of lithium ion intercalation or deintercalation, wherein the positive electrode active material is a mixture of a spinel structure material LiMnₓNiyO₄ and a laminated solid solution material zLi₂MnO₃*(1−z)LiMO₂ with a general formula of
p(LiMnₓNi_{y}O₄)*q[zLi₂MnO₃*(1−z)LiMO₂]
wherein: 0<p<1, 0<q<1, p+q=1; 0<x<2, 0<y<1, x+y=2; 0<z<1, M may be Co or Ni;
a negative electrode, wherein the negative electrode comprises a negative electrode active material capable of lithium ion intercalation or deintercalation; and
a non-aqueous organic electrolyte, comprising
(1) a lithium salt;
(2) a non-aqueous organic solvent, wherein the non-aqueous organic solvent comprises γ-butyrolactone and a saturated cyclic ester compound shown in formula (I), 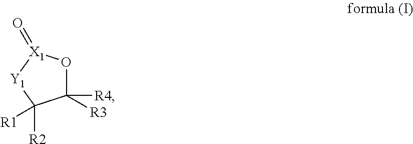
wherein X₁ is C, S or P group, Y₁ is O, CH₂ or CH₂CH₂, and R1, R2, R3 and R4 are independently hydrogen, halogen, cyano, nitro haloalkyl or perhaloalkyl, or C₁-C₆ alkoxy;
(3) an unsaturated cyclic ester compound shown in formula (II), 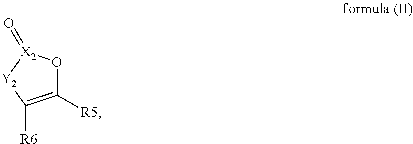
wherein X₂ is a C or S group, Y₂ is O, CH₂ or CH₂CH₂, and R5 and R6 are independently hydrogen, halogen, cyano, nitro, a haloalkyl or perhaloalkyl, or C₁-C₆ alkoxy; and
(4) a dinitrile compound shown in formula (III),
NC—R7-CN formula (III),
wherein R7 is a hydrocarbyl having one to fifteen carbon atoms.

12. The lithium ion secondary battery according to claim 11, wherein the saturated cyclic ester compound of formula (I) is one or more of the following: ethylene carbonate, propylene carbonate, ethyl sulfonate, propyl sulfonate, ethyl phosphate, propyl phosphate, fluoroethylene carbonate, fluoropropylene carbonate, difluoropropylene carbonate, trifluoropropylene glycol ester, fluoro-γ-butyrolactone, difluoro-γ-butyrolactone, chloropropylene carbonate, dichloropropylene carbonate, trichloropropylene glycol ester, chloro-γ-butyrolactone, dichloro-γ-butyrolactone, bromopropylene carbonate, dibromopropylene carbonate, tribromopropylene glycol ester, bromo-γ-butyrolactone, dibromo-γ-butyrolactone, nitropropylene carbonate, nitro-γ-butyrolactone, cyanopropylene carbonate, cyano-γ-butyrolactone, fluoroethyl sulfonate, fluoropropylene sulfonate, difluoropropylene sulfonate, trifluoropropylene sulfonate, fluoro-γ-butyrolactone sulfonate, difluoro-γ-butyrolactone sulfonate, chloropropylene sulfonate, dichloropropylene sulfonate, trichloropropylene sulfonate, chloro-γ-butyrolactone sulfonate, dichloro-γ-butyrolactone sulfonate, bromopropylene sulfonate, dibromopropylene sulfonate, tribromopropylene sulfonate, bromo-γ-butyrolactone sulfonate, dibromo-γ-butyrolactone sulfonate, nitropropylene sulfonate, nitro-γ-butyrolactone sulfonate, cyanopropylene sulfonate, cyano-γ-butyrolactone sulfonate, fluoroethyl phosphate, fluoropropylene phosphate, difluoropropylene phosphate, trifluoropropylene phosphate, fluoro-γ-butyrolactone phosphate, difluoro-γ-butyrolactone phosphate, chloropropylene phosphate, dichloropropylene phosphate, trichloropropylene phosphate, chloro-γ-butyrolactone phosphate, dichloro-γ-butyrolactone phosphate, bromopropylene phosphate, dibromopropylene phosphate, tribromopropylene phosphate, bromo-γ-butyrolactone phosphate, dibromo-γ-butyrolactone phosphate, nitropropylene phosphate, nitro-γ-butyrolactone phosphate, cyanopropylene phosphate, cyano-γ-butyrolactone phosphate, and saturated cyclic ester compound derivatives of the above substances with a partially halogenated or perhalogenated branched carbon chain or ether group having one to six carbon atoms.

13. The lithium ion secondary battery according to claim 11, wherein the non-aqueous organic solvent comprises 5-50% by volume of the saturated cyclic ester compound of formula (I).

14. The lithium ion secondary battery according to claim 11, wherein the non-aqueous organic solvent comprises γ-butyrolactone and the saturated cyclic ester compound of formula (I) in a volume ratio of 1:1 to 10:1.

15. The lithium ion secondary battery according to claim 11, wherein the unsaturated cyclic ester compound shown in formula (II) is one or more of the following: vinylene carbonate, fluorovinylene carbonate, difluorovinylene carbonate, chlorovinylene carbonate, dichlorovinylene carbonate, bromovinylene carbonate, dibromovinylene carbonate, nitrovinylene ester, cyanovinylene carbonate, vinylene sulfonate, fluorovinylene sulfonate, difluorovinylene sulfonate, chlorovinylene sulfonate, dichlorovinylene sulfonate, bromovinylene carbonate, dibromovinylene sulfonate, nitrovinylene sulfonate, cyanovinylene sulfonate, vinylene phosphate, fluorovinylene phosphate, difluorovinylene phosphate, chlorovinylene phosphate, dichlorovinylene phosphate, bromovinylene phosphate, dibromovinylene phosphate, nitrovinylene phosphate, cyanovinylene phosphate, 4-vinyl-4-methyl-1,3-dioxolan-2-one, 4-vinyl-4-ethyl-1,3-dioxolan-2-one, 4-vinyl-4-propyl-1,3-dioxolan-2-one, 4-vinyl-5-methyl-1,3-dioxolan-2-one, 4-vinyl-5-ethyl-1,3-dioxolan-2-one, 4-vinyl-5-propyl-1,3-dioxolan-2-one, and unsaturated cyclic ester compound derivatives thereof with a partially halogenated or perhalogenated branched carbon chain or ether group having one to six carbon atoms.

16. The lithium ion secondary battery according to claim 11, wherein the unsaturated cyclic ester compound shown in formula (II) in the non-aqueous organic solvent accounts for 0.5-5% by mass of the total mass of the non-aqueous organic solvent.

17. The lithium ion secondary battery according to claim 11, wherein the dinitrile compound is one or more of the following: succinonitrile, glutaronitrile, adiponitrile, 1,5-dicyanopentane, 1,6-dicyanohexane, 1,7-dicyanoheptane, 1,8-dicyanooctane, 1,9-dicyanononane, 1,10-dicyanodecane, 1,12-dicyanododecane, tetramethylsuccinonitrile, 2-methylglutaronitrile, 2,4-dimethylglutaronitrile, 2,2,4,4-tetramethylglutaronitrile, 2,5-dimethyl-2,5-hexanedinitrile, 1,2-dicyanobenzene, 1,3-dicyanobenzene, 1,4-dicyanobenzene, and dinitrile derivatives of the above substances with halogenated, nitro substitution.

18. The lithium ion secondary battery according to claim 11, wherein the dinitrile compound in the non-aqueous organic solvent accounts for 0.5-10% by mass of the total mass of the non-aqueous organic solvent.

19. The lithium ion secondary battery according to claim 11, wherein the non-aqueous organic electrolyte further comprises lithium bis(oxalate)borate.

20. The lithium ion secondary battery according to claim 19, wherein the lithium bis(oxalate)borate in the non-aqueous organic solvent accounts for 0.5-5% by mass of the total mass of the non-aqueous organic solvent.
